(19) United States
(12) Patent Application Publication
(10) Pub. No.: US 2018/0248983 A1
(43) Pub. Date: Aug. 30, 2018

(54) METHODS AND APPARATUS FOR AGGREGATING NETWORK ACCESS WITHIN A SINGLE UNIFIED PLATFORM FOR A MYRIAD OF DEVICES

(71) Applicant: nCore Communications, Inc., San Diego, CA (US)

(72) Inventors: Behzad Mohebbi, San Diego, CA (US); Gwain Bayley, San Diego, CA (US)

(21) Appl. No.: 15/849,063

(22) Filed: Dec. 20, 2017

Related U.S. Application Data
(60) Provisional application No. 62/437,587, filed on Dec. 21, 2016.
(60) Provisional application No. 62/442,848, filed on Jan. 5, 2017.

(51) Int. Cl. H04L 29/06; H04L 12/66; H04L 12/46; H04W 88/10

(52) U.S. Cl. CPC H04L 69/08; H04L 12/66; H04L 67/12; H04W 88/10; H04L 12/4633

(57) ABSTRACT

Apparatus and methods for a single Internet of Things (IoT) and Industrial IoT (IIoT) unified platform. In disclosed embodiments, a protocol stack for an end-device can be modified to interoperate with a common interface over different radio technologies. Since the protocol stack for a user equipment conforms to a common signaling protocol (even though the two or more portions are separately executed in different nodes), the a unified (common) interface technology can be used. A unified network can facilitate security, roaming, Quality of Service (QoS) and mobility features, with different access technologies. A single unified IoT/IIoT core also enables roaming between similar or dissimilar access technologies, thereby providing seamless IoT/IIoT connectivity.

### PRIORITY AND RELATED APPLICATIONS

This application claims priority to co-pending U.S. Provisional patent application Ser. No. 62/437,587 filed on Dec. 21, 2016 and entitled “METHODS AND APPARATUS FOR AGGREGATING NETWORK ACCESS WITHIN A SINGLE UNIFIED PLATFORM FOR A MYRIAD OF DEVICES”, and 62/442,848 filed on Jan. 5, 2017 and entitled “METHODS AND APPARATUS FOR AGGREGATING NETWORK ACCESS WITHIN A SINGLE UNIFIED PLATFORM FOR A MYRIAD OF DEVICES”, each of the foregoing being incorporated herein by reference in its entirety.

This application is related to co-owned and co-pending U.S. patent application Ser. No. 14/863,239 entitled “METHODS AND APPARATUS FOR HYBRID ACCESS TO A CORE NETWORK BASED ON PROXIED AUTHENTICATION”, filed Sep. 23, 2015, which claims priority to U.S. Provisional Patent Application Ser. No. 62/071,517 entitled “METHODS AND APPARATUS FOR HYBRID ACCESS TO A CORE NETWORK”, filed Sep. 25, 2014, and co-owned U.S. patent application Ser. No. 14/156,339 entitled “METHODS AND APPARATUS FOR HYBRID ACCESS TO A CORE NETWORK”, filed Jan. 15, 2014, and issued as U.S. Pat. No. 9,603,192, on Mar. 21, 2017, which claims priority to U.S. Provisional Patent Application Ser. No. 61/848,950 filed on Jan. 16, 2013 and entitled “WI-FI OVER LTE NETWORK (WOLTEN)”, each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### 1. Field of Invention

The present invention relates generally to the field of wireless communication and data networks. More particularly, in one exemplary aspect, the invention is directed to methods and apparatus for aggregating network access for a myriad of devices.

### 2. Description of Related Technology

Consumer demand for Internet of Things (IoT) and Industrial IoT (IIoT) deployments have rapidly increased. Various service providers use a number of connectivity platforms to support IoT and IIoT devices and services. For example, common examples include without limitation: cellular networks (e.g., Global System for Mobile Communications (GSM) (Release 8), EC-GSM-IoT (Extended Coverage GSM for IoT) (Release 13), Long Term Evolution (LTE) (Release 8), enhanced Machine Type Communications (eMTC) (Release 13), Narrowband IoT (NB-IoT) (Release 13)), Wireless Local Area Networks (WLAN) (e.g., Wi-Fi), and LoRaWAN (Long Range Wide Area Network).

Unfortunately, IoT/IIoT applications and deployment scenarios widely vary, consequently there is no unified solution for the various requirements. For example, LTE NB-IoT is suitable for outdoor, high mobility, low data-rate and low data-volume applications (e.g. fleet management); however, NB-IoT requires licensed frequency bands for operation. Wi-Fi solutions are suitable for indoor, low mobility, high data-rate and high data-volume applications but have limited operating ranges (e.g., no more than one (1) kilometer (km)). LoRaWAN can support communications over very large distances (e.g., nearly thirty (30) kilometers (km)), but lacks some features that may be required for certain IoT applications.

The multiplicity of the IoT/IIoT platforms and radio access technologies have left service providers with the challenge of managing several independent networks with little or no interworking capabilities. The lack of integration and interoperability between the different networks and access technologies lead to higher complexity, cost and network duplication.

### SUMMARY OF THE INVENTION

The present invention satisfies the aforementioned needs by providing, inter alia, improved apparatus and methods for aggregating network access for a myriad of devices.

A method for aggregating network access for a myriad of devices is disclosed. In one embodiment, the method includes: modifying a first protocol stack for each one of the myriad of devices; executing a common portion of the first protocol stack within a second protocol stack, wherein the second protocol stack enables communication with a base station corresponding to the each one of the myriad of devices; aggregating communications within an aggregating gateway; and communicating from the aggregating gateway with a core network according to the first protocol.

A non-transitory computer readable medium is disclosed. In one embodiment, the non-transitory computer readable medium is configured to cause, when executed: modification of a first protocol stack for each one of the myriad of devices; execution of a common portion of the first protocol stack within a second protocol stack, wherein the second protocol stack enables communication with a base station corresponding to the each one of the myriad of devices; aggregation of communications within an aggregating gateway; and communication from the aggregating gateway with a core network according to the first protocol.

An aggregating gateway apparatus, gateway apparatus, and network server apparatus is disclosed. The aggregating gateway apparatus, gateway apparatus, and/or network server, are configured to, either alone or in combination, aggregate network access for a myriad of devices. In at least one variant, the aggregating gateway apparatus, gateway apparatus, and/or network server, are configured to, either alone or in combination, communicate with a core network according to a first protocol.

An end-device is disclosed that communicates with a core network according to a first protocol, via one or more intermediary entities.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1 is a graphical representation of a single unified core network, useful in conjunction with various embodiments of the present disclosure.

FIG. 2 is an exemplary block diagram of an exemplary access point (AP) providing hybrid access to a core network, useful in conjunction with various embodiments of the present disclosure.

FIG. 3 is a generalized block diagram of a single unified core network augmented with an aggregation gateway, in accordance with the principles described herein.

FIG. 4 is one generalized implementation of a LoRaWAN network server for use within a single unified core network, in accordance with the principles described herein.

FIG. 5 is a first exemplary implementation of a LoRaWAN network server optimized for a single unified core network, in accordance with the principles described herein.

FIG. 6 is a second exemplary implementation of a LoRaWAN network server optimized for a single unified core network, in accordance with the principles described herein.

FIG. 7 is a third exemplary implementation of a LoRaWAN network server optimized for a single unified core network, in accordance with the principles described herein.

FIG. 8 is a logical representation of a single unified core network software, in accordance with the principles described herein.

### DETAILED DESCRIPTION OF THE INVENTION

Reference is now made to the drawings, wherein like numerals refer to like parts throughout.

### Detailed Description of Exemplary Embodiments

Exemplary embodiments of the present invention are now described in detail. While these embodiments are primarily discussed in the context of a fourth generation Long Term Evolution (4G LTE) wireless network in combination with LoRaWAN (Long Range Wide Area Network) operation, it will be recognized by those of ordinary skill that the present invention is not so limited. In fact, the various aspects of the invention are useful in any wireless network that can support the wireless routing schemes described herein.

Furthermore, while the following embodiments are primarily discussed in the context of an Internet of Things (IoT) and Industrial IoT (IIoT) operation, it will be recognized by those of ordinary skill that the present invention is not so limited, IoT and IIoT deployments enable “connected devices” and/or “smart devices” (more generally referred to as “things”) to collect and exchange data without human interaction, while operating as an infrastructure for a larger network. To these ends, IoT and IIoT rely on unique identification for each device (that are far more numerous than human users) to interoperate within the existing network. Accordingly, the various aspects of the invention are useful in any wireless network that must support a myriad of devices.

As used herein, the term “wireless” means any wireless signal, data, communication, or other interface including without limitation Wi-Fi (IEEE 802.11 and its derivatives such as “b”, “a”, “g”, “n”, “ac”, etc.), Bluetooth, 3G (e.g., 3GPP, 3GPP2, and UMTS), 4G (LTE, LTE-A, WiMax), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

Furthermore, as used herein, the term “network” refers generally to any type of data, telecommunications or other network including, without limitation, data networks (including MANs, PANs, WANs, LANs, WLANs, micronets, piconets, internets, and intranets), satellite networks, cellular networks, and telco networks.

### Example Network

Methods and apparatus that enable a single platform for IoT/IIoT connectivity are disclosed herein. In one embodiment, the exemplary platform is based on a single core network that unifies different radio access technologies and provides a unified platform to meet the service requirements and use-case scenarios for IoT and IIoT applications.

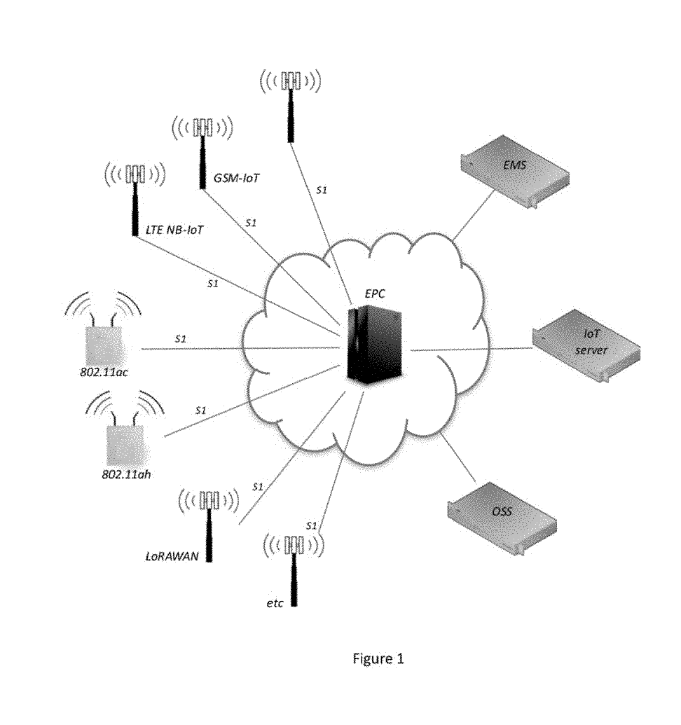

FIG. 1 is a graphical representation of a unified platform (IoT/IIoT devices not shown), useful in conjunction with various embodiments of the present disclosure. As depicted in FIG. 1, a single unified LTE core network (Evolved Packet Core (EPC)) supports multiple different radio access technologies, such as EC-GSM-IoT (Extended Coverage GSM for IoT) (Release 13), Long Term Evolution (LTE) (Release 8), Narrowband IoT (NB-IoT) (Release 13)), Wireless Local Area Networks (WLAN) (e.g., Wi-Fi), and LoRaWAN (Long Range Wide Area Network).

In one exemplary embodiment, each of the different radio access technologies are modified to directly connect to the EPC via an LTE-compliant (or “standard”) so-called “S1” interface. As a brief aside, the S1 interface is the interface between the LTE radio access network (RAN) and evolved packet core (EPC). The S1 interface communicates both user plane and control plane data. User plane data includes LTE user plane Protocol Data Units (PDUs). Control plane data includes signaling protocols for mobility management and other call control information; common examples include without limitation Evolved Packet System (EPS) bearer setup/release procedures, handover signaling, paging signaling and the non-access stratum (NAS) transport signaling. Control plane data is provided on a guaranteed delivery basis.

While the illustrated embodiment of FIG. 1 is based on an LTE EPC, artisans of ordinary skill in the related arts will readily appreciate that other core network technologies may be substituted with equal success, given the contents of the present disclosure. More generally, as used herein, the term “core network” refers to any centralized network entity that is configured to manage and provide services to end-devices connected by an access network.

More generally, the term “communication system” refers to any collection of individual communications networks, transmission systems, and other network equipment, used to transact data between devices. Any number of communication system technologies may be substituted with equal success, given the contents of the present disclosure. Various techniques for modifying different radio access technologies for hybrid access to a core network are described in greater detail within e.g., co-owned and co-pending U.S. patent application Ser. No. 14/863,239 entitled “METHODS AND APPARATUS FOR HYBRID ACCESS TO A CORE NETWORK BASED ON PROXIED AUTHENTICATION”, filed Sep. 23, 2015, which claims priority to U.S. Provisional Patent Application Ser. No. 62/071,517 entitled “METHODS AND APPARATUS FOR HYBRID ACCESS TO A CORE NETWORK”, filed Sep. 25, 2014, and co-owned U.S. patent application Ser. No. 14/156,339 entitled “METHODS AND APPARATUS FOR HYBRID ACCESS TO A CORE NETWORK”, filed Jan. 15, 2014, and issued as U.S. Pat. No. 9,603,192, on Mar. 21, 2017, which claims priority to U.S. Provisional Patent Application Ser. No. 61/848,950 filed on Jan. 16, 2013 and entitled “WI-FI OVER LTE NETWORK (WOLTEN)”, each of the foregoing incorporated previously by reference in its entirety. More directly, as described therein, a LTE protocol stack for a user equipment can be modified by e.g., (i) splitting the protocol stack into a first portion of layers and a second portion of layers, (ii) executing the first portion of layers within a first node (e.g., the UE), and causing a second node (e.g., a Wi-Fi AP) to execute the second portion of layers, and communicating data payloads via a S1 interface. Since the LTE protocol stack for a user equipment conforms to LTE signaling protocols (even though the two portions are separately executed in different nodes), the Wi-Fi AP can transact the data payloads directly via the LTE S1 interface. By extension, modifying the protocol stack for each of the underlying radio access networks (RANs) and executing a LTE protocol stack within the attached IoT devices enables all of the constituent RANs to operate with the common EPC (e.g., via the S1 interface). For example, an IoT device connected to the Wi-Fi AP, can communicate with the LTE EPC.

One advantage of a single unified IoT/IIoT platform (such as the system described in FIG. 1), is that the network nodes have a unified network and corresponding unified network identity that can facilitate common security, roaming, Quality of Service (QoS) and mobility features, with different access technologies. Common examples of such end-devices include without limitation IoT/IIoT devices, IoT/IIoT hubs, and base stations (Wi-Fi APs, LTE eNBs, Lora Gateways, etc.) Additionally, the service provider operates only a single network, which results in reduced cost and complexity. Still further, the service provider can select a IoT/IIoT connectivity access technology from a set of available technologies based on: (i) operating conditions, (ii) cost of connectivity, (iii) load and congestion of the access technologies, and (iv) any other considerations that impact on performance and cost. A single unified IoT/IIoT core also enables roaming between similar or dissimilar access technologies, thereby providing seamless IoT/IIoT connectivity. A single core can connect machines with similar or dissimilar access technologies to each other.

While existing LTE EPCs already enable mobile-to-mobile communication (using unique LTE network specific identifiers), various embodiments of the present disclosure extend the functionality to device-to-device communication by providing unique identifiers for IoT/IIoT devices. In some embodiments, a single core network (e.g., the LTE EPC and/or IoT Server) can function as a mediator, enabling communications between two or more IoT/IIoT end-devices with similar or dissimilar access technologies. The mediated connectivity between IoT/IIoT end-devices can be routed via the core EPC or the IoT Server (shown in FIG. 1) or directly between devices, which are initialized and configured for such direct communication by the EPC or IoT Server. Further, the identity of a device in the LTE core (e.g. a number, name, IMSI, or other unique identifier, within the LTE core), can be used by other devices for discovery and communications with a given IoT/IIoT device. More directly, the unique identity of the device within the LTE core enables device-to-device communication.

In some embodiments, the IoT server (or a modified EPC core) can configure the IoT/IIoT end-devices for direct communication by provisioning common security and cyphering keys. For example, the IoT Server may have one or more USIMs for authentication and key generation with LTE core network. The generated keys can then be shared with the devices for direct communication between the devices. Still other schemes may be used to enable the IoT server to use any desired encryption key to share with the devices, for security in a direct communication between the devices. After the two or more IoT/IIoT end-devices authenticate with the core network (EPC) and during initialization of the direct-mode connection, the IoT server or EPC (as modified to support device-to-device communication) can issue a set of shared “fresh” encryption keys to the end-devices (as discussed above), which can be used for cyphering and deciphering of the communication data that is exchanged between two machines directly. These keys can also be changed from time to time, with IoT server or EPC supervision and mediation, for continued security.

Other examples of commonly controlled initialization parameters include, without limitation, the required quality of the link (based on a shared metric e.g., Quality of Service (QoS)), scheduled transmission times, and/or other communication protocol parameters. The core can also provide mobility and roaming for end-devices with similar or dissimilar access technologies in communications with each other, e.g., allowing data traffic to traverse through the core.

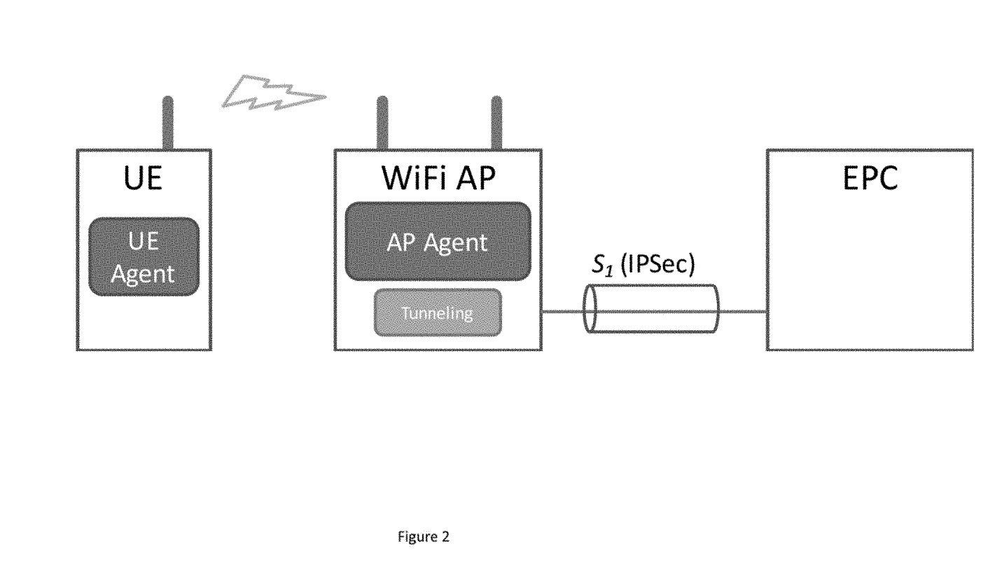

In some embodiments, an EPC is directly coupled to a different access technology (such as a Wi-Fi AP), by deploying two or more software (SW) “agents” within the link endpoints. More directly, a first SW agent is located in the end-device and a complementary SW agent is located at the network entity (e.g., the Wi-Fi AP). Together, the two SW agents have the required functionalities and protocol stack layers, including the non-access stratum (NAS) layer, to attach an end-device to the EPC core and manage and setup the appropriate EPC bearers for data connectivity. The Wi-Fi AP may also be modified to include the software or hardware components for tunneling and interfacing (GTP, S1-AP, X2-AP, etc) the Wi-Fi AP to the EPC. A simplified example block diagram is shown in FIG. 2. Artisans of ordinary skill in the related arts will readily appreciate that the UE illustrated within FIG. 2 may be an end-device for an IoT/IIoT network.

Referring back to FIG. 1, the illustrated unified network can include different access technologies, including the aforementioned LTE-over-WiFi. However, the architecture shown in FIG. 1 is optimized for use within typical LTE macro cell network deployments and may not be ideal (or even practical) for IoT/IIoT requirements where larger numbers of base stations (e.g., access points (APs), evolved NodeBs (eNBs), LoRa gateways, and/or similar network connection points) and end-devices are expected to be supported. In particular, the aforementioned architecture may have limitations on EPC Internet Protocol (IP) ports and physical connections, which also limits the number of supported base stations that an EPC can handle directly.

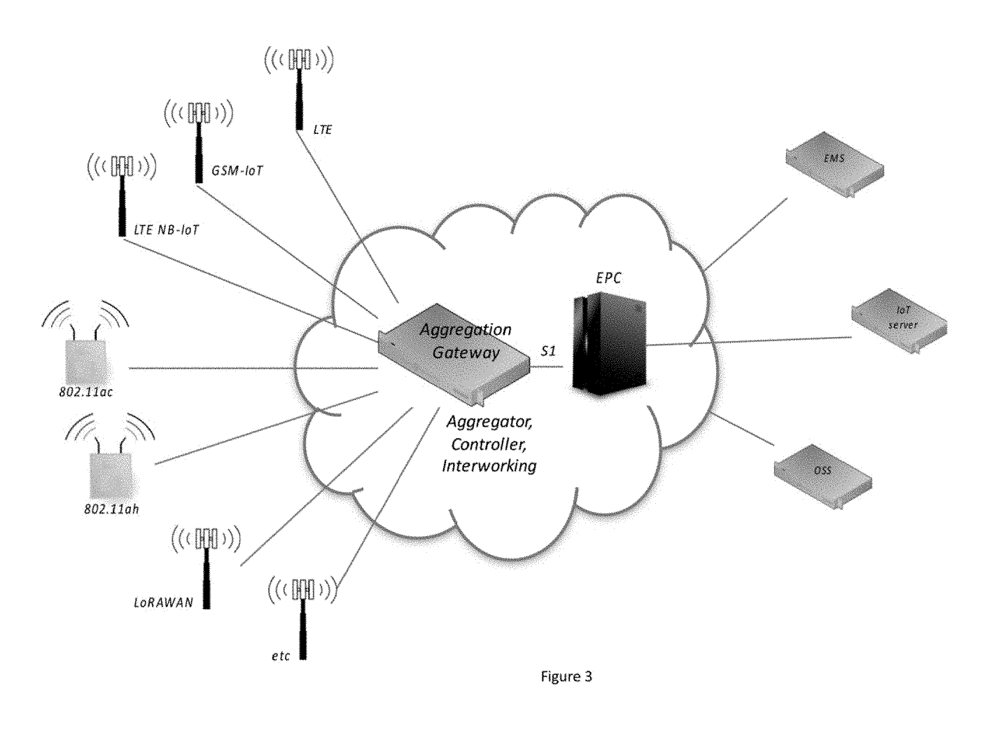

To these ends, FIG. 3 illustrates an improved architecture for IoT/IIoT connectivity that aggregates communication links from multiple radio access technologies over a common network interface to a core network. The architectures of FIG. 1 and FIG. 3 are substantially similar with regard to overall functionalities and operation, however, FIG. 3 includes an “aggregation gateway” that: (i) aggregates data traffic and physical connections from different base stations to reduce virtual and physical connections to the EPC, (ii) controls the connected base station nodes (APs, LTE eNBs, LoRa Gateway, etc.), and (iii) supports interworking functionality for direct connection of different access technologies to the EPC through the standard S1 interface. As shown, the aggregation gateway supports an “AP Agent” and the associated tunneling software and hardware components (GTP, S1-AP, X2-AP, etc.) for LTE-over-WiFi access, so as to aggregate and connect the base stations (e.g., access points (APs), evolved NodeBs (eNBs), LoRa gateways, and/or similar network connection points) to the EPC, and facilitate the operation of LTE-over-WiFi.

While the foregoing solutions can connect and support different non-LTE access technologies to an EPC core, various embodiments of the present disclosure may be further optimized for each individual access technology. For example, LoRaWAN has a number of design features that diverge from other access technologies such as LTE or Wi-Fi. In particular, LoRaWAN logically separates the “base station” entity into a LoRa Network Server, and a LoRa Gateway. Splitting the traditional base station paradigm into two distinct entities introduces additional layers of complexity that require consideration.

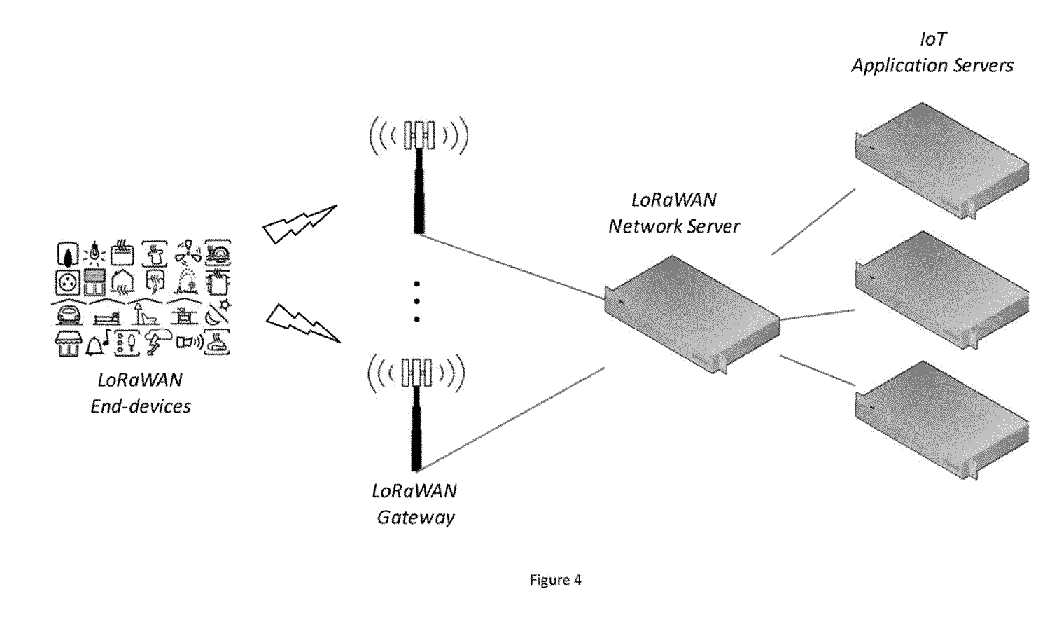

FIG. 4 illustrates one exemplary LoRaWAN network that is designed for low-power, long-range operation. LoRaWAN uses chirp spread spectrum modulation which is ideal for applications requiring low power usage and limited to relatively low data rates. Typically, LoRaWAN end-devices are IoT/IIoT devices that are used for e.g., control and sensing. LoRaWAN end-devices are normally located remotely and communicate with LoRa gateways (base stations) wirelessly, via a LoRa physical layer. The LoRa gateway only manages low level reception (e.g., PHY and MAC layers) and does not perform higher level network tasks such as e.g., association. Each LoRa Gateway receives packets from the end-devices on the uplink and transfers them to a LoRa Network Server for further higher layer processing. For example, a transmission from a LoRa end-device may be received at multiple LoRa gateways, resulting in multiple duplicative packet receptions.

The LoRa network server performs higher layer protocols; notably, the LoRa network server manages the network and is responsible for (among other tasks): (i) counting frames, (ii) selecting LoRa gateways for downlink packet transmissions, (iii) eliminating duplicate uplink packets received from various LoRa gateways, (iv) performing rate-adaptation and selection of an appropriate data rate for communications with an end-device, (v) encrypting and decrypting packets exchanged with the end-devices, (vi) over the air (OTA) activation of the end-devices, and (vii) scheduling acknowledgements.

As a brief aside, Wi-Fi and cellular systems perform most or all of the aforementioned tasks (of the PHY and MAC and other protocol stack layers) at a single base station entity (AP, eNB). However, since the LoRaWAN network server and gateway are separate, artisans of ordinary skill in the related arts will readily appreciate that the aforementioned solutions for splitting a user equipment protocol stack may not be straightforward. For example, in some implementations rate-adaptation can be supported in a LoRa gateway, while duplicate packet handling could be handled at a LoRa application server. In other implementations, these tasks may be integrated at the LoRa network server. In still other implementations, network management may be performed by an aggregation gateway. Additionally, in some cases, combining the LoRa network server and LoRa aggregation gateway can be a less intrusive solution because an integrated platform will have access to both logical functionalities.

The following discussions provide multiple different solutions for directly connecting LoRa gateways, a LoRa network server, a LoRa aggregation gateway, (or some hybrid of the entities) with an EPC core network via the LTE-compliant (“standard”) S1 interface.

### Example Variant #1

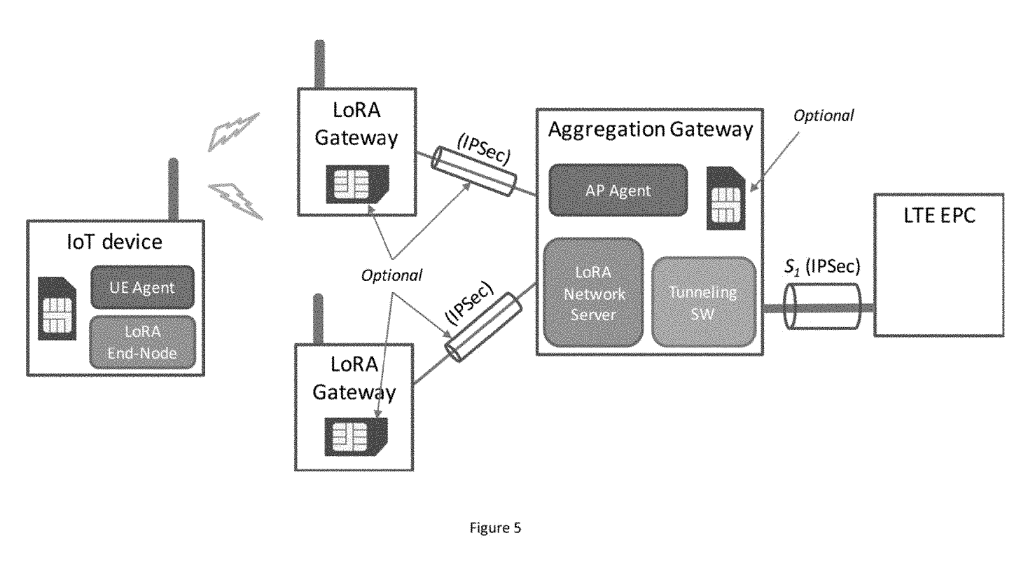

FIG. 5 is a first exemplary implementation of a LoRa network server optimized for a single unified core network, in accordance with the principles described herein. In this example variant, the LoRa network server is integrated with the aggregation gateway as a single network entity.

In the illustrated embodiment, the LoRaWAN end-device and/or aggregation gateway are further modified to enable USIM card operation (Universal Subscriber Identity Module) or a software implementation of the USIM (SW-USIM) at a LoRaWAN end-device. A SW-USIM performs the USIM algorithms within software; specifically, the USIM security information is securely stored within the device's secure memory (or encrypted on unsecure memory) and the USIM algorithms executed on the device processor. Additionally, the processor supports a “UE Agent”; the UE agent can authenticate and attach to an LTE core network. In some variants, the USIM functionality should not be performed within the device; instead, the device USIM functionality is managed in other network nodes such as the aggregation gateway. For example, the aggregation gateway can use the USIM functionality (by proxy) to attach one or more devices to the LTE core network.

In one such variant, the LoRa network server and LoRa end-device replace the LoRa “network session key” (NwkSKey) (defined by the “LoRaWAN Specification”, version 1.0, published January 2015, incorporated herein by reference in its entirety) with an LTE security key. The LoRa network session key and the LTE keys may be characterized by different lengths; consequently, the LTE key can be modified to have the same length as the LoRa network session key. In one such case, the LTE key can be truncated if the LTE key is longer than LoRa NwkSKey (until the LTE key is the same length as the LoRa NwkSKey). Alternatively, the LTE key can be extended by repeating and appending a known part of the LTE key onto itself (until the LTE key is the same length as LoRa NwkSKey). As a brief aside, the LTE key is not being used for an LTE air interface; rather the LTE key is used as a more secure replacement key for the LoRa air interface. Still other very large random numbers or keys may be used with equal success, the foregoing modification being purely illustrative.

In some implementations, the LoRa Application Session Key (AppSKey) is optional and can be eliminated; conversely, the LoRa AppSkey may be maintained and operated as specified in the aforementioned LoRaWAN Specification, with modifications for the appropriate LoRaWAN air interface. Common examples of such modification include padding, truncation, repetition, replacement, and/or any other manner of substitution in whole or in part.

In another such variant, the aggregation gateway associates and maps the LoRa network server end-device identifiers and the LTE-over-WiFi/LTE UE identifiers. Common examples of LoRaWAN end-device identifiers include e.g., “Device Address” (DevAddr), “End-device Identifier” (DevEUI). Common examples of LTE UE (device) identifiers include without limitation e.g., IP address, IMSI (International Mobile Subscriber Identity), IMEI (International Mobile Equipment Identity), GUTI (Globally Unique Temporary Identifier), TEID (Tunnel endpoint identifier), and any SW identifiers for internal operation of UE and AP Agents. During operation, the end-to-end connection is setup and maintained according to the shared mapping of the LoRa network server end-device identifiers and the LTE-over-WiFi/LTE UE identifiers.

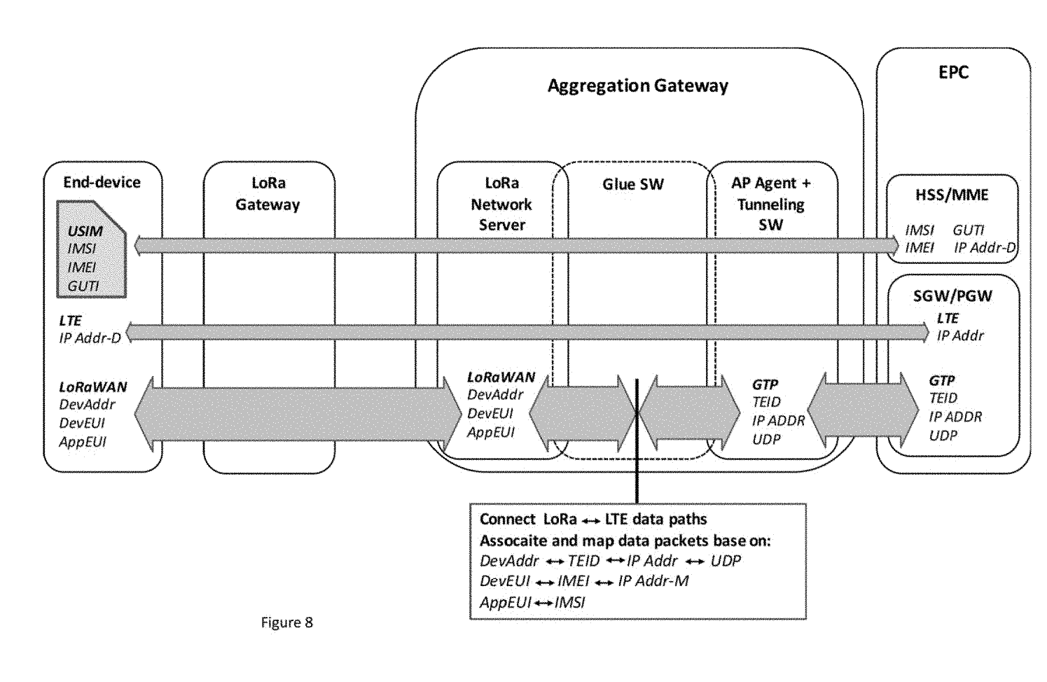

Similarly, other network identifiers may be mapped to one another in order to support cross-network operation. Common examples of other such identifiers include, without limitation, the LoRa “Application identifier” (AppEUI) association. In one exemplary variant, the AppEUI is mapped to a EPC bearer identifier such as the IMSI, TEID and/or LTE APN (Access Point Name). Exemplary mappings are provided and discussed in greater detail hereinafter (see e.g., FIG. 8 and the associated description, infra “Exemplary Glue Software”).

In one embodiment, the LoRa end-device is required to authenticate with the LTE core network (EPC) and generate a number of security keys before initiating communication. To these ends, the UE agent and AP agent facilitate the authentication and generation of security keys. After the generation of LTE security keys in the end-device and the aggregation gateway, the aggregation gateway passes the generated key to the LoRa network server. Thereafter, the LoRa network server uses the key in place of the LoRa “network session key” (NwkSKey) (as defined by the “LoRaWAN Specification”, version 1.0, published January 2015, incorporated previously), in the same manner as the original LoRa network session key (NwkSKey), as appropriately modified (see foregoing discussion). The end-device will also use the LTE generated security key (which corresponds to the security key used by the LoRa network server) for encryption and decryption of the outgoing and incoming packets respectively. After the generation of the security keys, the resulting security key is used in the LoRa end-point to encrypt uplink packets and decrypt downlink packets, while the corresponding security key in the LoRa network server (logically residing in the aggregation gateway) is used to decrypt uplink packets and encrypt the downlink packets.

After authentication and initial attachment to the LTE network, the UE and AP agents in FIG. 5 communicate through the LoRaWAN network. In some cases, the UE and AP agents use a dedicated local IP address (if necessary) to exchange configuration information. During the initial configuration exchanges, the UE agent will inform the AP agent of the end-device target IoT/IIoT server. In some variants, the UE agent will also inform the AP agent of the target IoT/IIoT server IP Address. Using this information, the AP agent can setup a dedicated LTE bearer (EPS) or use the existing default bearer to support packet transfer to and from the target IoT/IIoT server and the AP agent. During subsequent transfers, the data packets are exchanged between the AP agent and the LoRa network server.

In some implementations the AP agent and the LoRa network server may additionally use one or more intermediate software abstraction layers. This so-called “Glue Software (SW)” facilitates data packet exchanges by associating and mapping the end-device LoRaWAN identity to LTE UE identity. One exemplary implementation of Glue SW is discussed in greater detail infra (see e.g., FIG. 8 and the associated description, infra “Exemplary Glue Software”).

Referring back to FIG. 5, the data packet exchanges between the end-device and the LoRa network server, and the operation of the LoRaWAN part of the composite network, can occur with substantially the same protocols as specified within the LoRaWAN operation (as defined by the “LoRaWAN Specification”, version 1.0, published January 2015, incorporated previously). In FIG. 5, an IPSec tunnel to the LTE EPC is mandatory for all entities external to the EPC as specified by LTE 3GPP standards bodies (www.3gpp.org); thus, an IPSec tunnel must exist between the aggregation gateway and the LTE EPC to conform to LTE EPC operation. However, an IPSec tunnel between the LoRa gateway and the aggregation gateway (neither of which are LTE core entities) may be optionally implemented.

Some variants may include other optional features; common examples of such features include, without limitation, USIM card operation and/or SW USIM operation. Optional features may be implemented within the LoRa gateway, so as to enable the network to authenticate the LoRa gateway identity via EPC.

### Example Variant #2

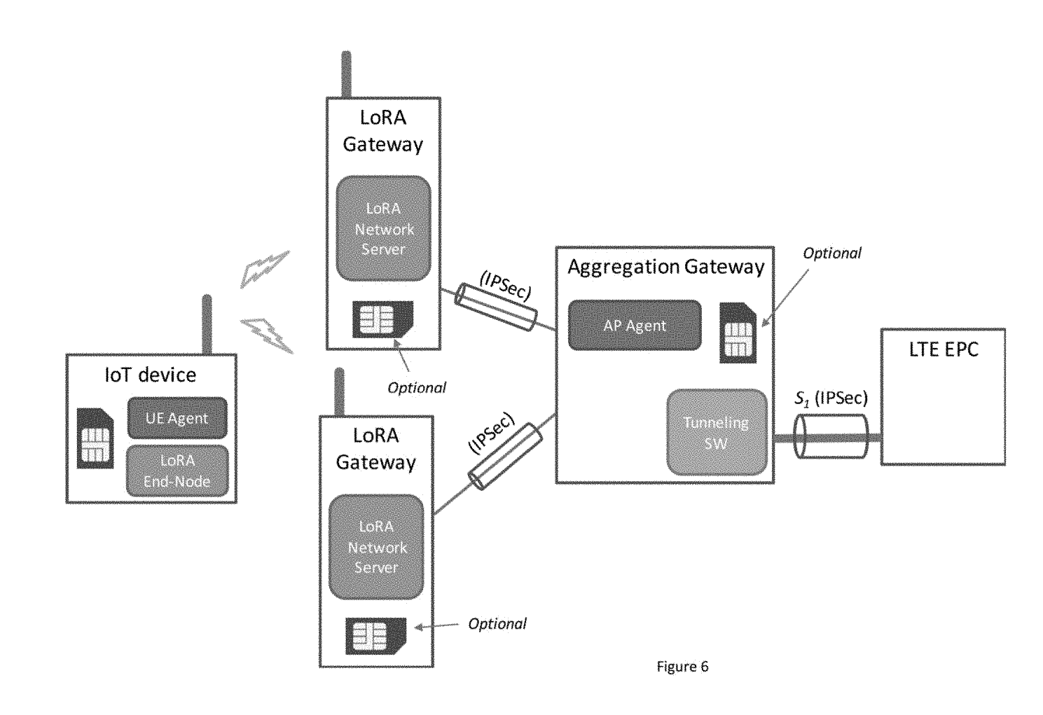

FIG. 6 is a second exemplary implementation of a LoRaWAN network server optimized for a single unified core network, in accordance with the principles described herein. While FIG. 5 performed network server functionality within the aggregated gateway, the LoRaWAN network server functionalities could be performed by other nodes (such as the LoRa gateways). In the example shown in FIG. 6, at least a portion of the LoRa network server functionalities are relocated/reallocated to the LoRa gateways. For example, the LoRa gateway can forward the uplink received packets based on the initial LTE association and authentication of the end-device, otherwise when the end-device is not associated/authenticated then the LoRa gateway ignores the received packets.

Unfortunately, in some variants, the IoT/IIoT end-device will only associate to a single LoRa network server. Since the individual LoRa network servers may not cross communicate, mobility may not be supported in the LoRa part of the network for such implementations.

In the illustrated embodiment of FIG. 6, the LoRa network server is integrated with the LoRa gateway. In one such exemplary embodiment, the LoRaWAN end-device and/or aggregation gateway have been modified to support a USIM card (Universal Subscriber Identity Module) or a SW implementation of the USIM (SW-USIM). As previously noted, the SW-USIM is the SW implementation of the USIM algorithms, with the USIM information kept within a device's secure memory (or encrypted on the device's unsecure memory) and the USIM algorithms executed on a device processor.

Similarly, the processor supports a “UE Agent”; the UE agent can authenticate and attach to an LTE core network. In some variants, the USIM functionality should not be performed within the device; instead, the device USIM functionality is managed in other network nodes such as the aggregation gateway. For example, the aggregation gateway can use the USIM functionality (by proxy) to attach one or more devices to the LTE core network.

In one such variant, the LoRa network server and LoRa end-device replace the LoRa “network session key” (NwkSKey) (defined by the “LoRaWAN Specification”, version 1.0, published January 2015, incorporated herein by reference in its entirety) with an LTE security key. The LoRa network session key and the LTE keys may be characterized by different lengths; consequently, the LTE key can be modified to have the same length as the LoRa network session key. In one such case, the LTE key can be truncated if the LTE key is longer than LoRa NwkSKey (until the LTE key is the same length as the LoRa NwkSKey). Alternatively, the LTE key can be extended by repeating and appending a known part of the LTE key onto itself (until the LTE key is the same length as LoRa NwkSKey). In some implementations, the LoRa Application Session Key (AppSKey) is optional and can be eliminated; conversely, the LoRa AppSkey may be maintained and operated as specified in the aforementioned LoRaWAN Specification. Still other variants may be substituted with equal success by those of ordinary skill in the related arts, with appropriate modifications.

In another such variant, the aggregation gateway associates and maps the LoRa network server end-device identifiers and the LTE-over-WiFi/LTE UE identifiers. Common examples of LoRaWAN end-device identifiers include e.g., “Device Address” (DevAddr), “End-device Identifier” (DevEUI). Common examples of LTE UE (device) identifiers include without limitation e.g., IP address, IMSI (International Mobile Subscriber Identity), IMEI (International Mobile Equipment Identity), GUTI (Globally Unique Temporary Identifier), TEID (Tunnel endpoint identifier), and any SW identifiers for internal operation of UE and AP Agents. During operation, the end-to-end connection is setup and maintained according to the shared mapping of the LoRa network server end-device identifiers and the LTE-over-WiFi/LTE UE identifiers.

Similarly, other network identifiers may be mapped to one another in order to support cross-network operation. Common examples of other such identifiers include, without limitation, the LoRa “Application identifier” (AppEUI) association. In one exemplary variant, the AppEUI is mapped to a EPC bearer identifier such as the IMSI, TEID and/or LTE APN (Access Point Name). Exemplary mappings are provided and discussed in greater detail hereinafter (see e.g., FIG. 8 and the associated description, infra “Exemplary Glue Software”).

As previously noted, the LoRa end-device may be required to authenticate with the LTE core network (EPC) and generate a number of security keys before initiating communication. To these ends, the UE agent and AP agent facilitate the authentication and generation of security keys. After the generation of LTE security keys in the end-device and the aggregation gateway, the aggregation gateway passes the generated key to the LoRa network server. Thereafter, the LoRa network server uses the key in place of the LoRa “network session key” (NwkSKey) (as defined by the “LoRaWAN Specification”, version 1.0, published January 2015, incorporated previously), in the same manner as the original LoRa network session key (NwkSKey), as appropriately modified (see supra). The end-device will also use the LTE generated security key (which corresponds to the security key used by the LoRa network server) for encryption and decryption of the outgoing and incoming packets respectively. After the generation of the security keys, the resulting security key is used in the LoRa end-point to encrypt uplink packets and decrypt downlink packets, while the corresponding security key in the LoRa network server (logically residing in the aggregation gateway) is used to decrypt uplink packets and encrypt the downlink packets.

After authentication and initial attachment to the LTE network, the UE and AP agents in FIG. 6 communicate through the LoRaWAN network. In some cases, the UE and AP agents use a dedicated local IP address (if necessary) to exchange configuration information. During the initial configuration exchanges, the UE agent will inform the AP agent of the end-device target IoT/IIoT server. In some variants, the UE agent will also inform the AP agent of the target IoT/IIoT server IP Address. Using this information, the AP agent can setup a dedicated LTE bearer (EPS) or use the existing default bearer to support packet transfer to and from the target IoT/IIoT server and the AP agent. During subsequent transfers, the data packets are exchanged between the AP agent and the LoRa network server.

In some implementations the AP agent and the LoRa network server may additionally use one or more intermediate software abstraction layers. In one variant, the intermediate software abstraction layer is a Glue SW that facilitates data packet exchanges by associating and mapping the end-device LoRaWAN identity to LTE UE identity. One exemplary implementation of Glue SW is discussed in greater detail infra (see e.g., FIG. 8 and the associated description, infra “Exemplary Glue Software”). In one such implementation, the Glue SW may be modified by passing the LoRa DevAddr from the LoRa network server to the Glue SW (located within the aggregation gateway) so as to enable the Glue SW to appropriately map to the LTE identities used for the S1 interface.

Artisans of ordinary skill in the related arts will readily appreciate that the data packet exchanges between the end-device and the LoRa gateway shown in FIG. 6, are substantially the same as the LoRaWAN operation (as defined by the “LoRaWAN Specification”, version 1.0, published January 2015, incorporated previously). Furthermore, those of ordinary skill will readily appreciate, given the foregoing discussion, that one benefit of the various aforementioned embodiment is that the LoRa end-devices can determine the identity of the LoRa gateway they communicate with. Additionally, since the encryption and decryption occurs at the LoRa gateway, an IPSec tunnel must be present between the LoRa gateway and the aggregation gateway so that security can be maintained end-to-end in accordance with LTE requirements.

Some variants may include optional features; common examples of such optional features include, without limitation, USIM card operation and/or SW USIM operation. Optional features may be implemented within the LoRa gateway, so as to enable the network to authenticate the LoRa gateway identity via EPC.

### Example Variant #3

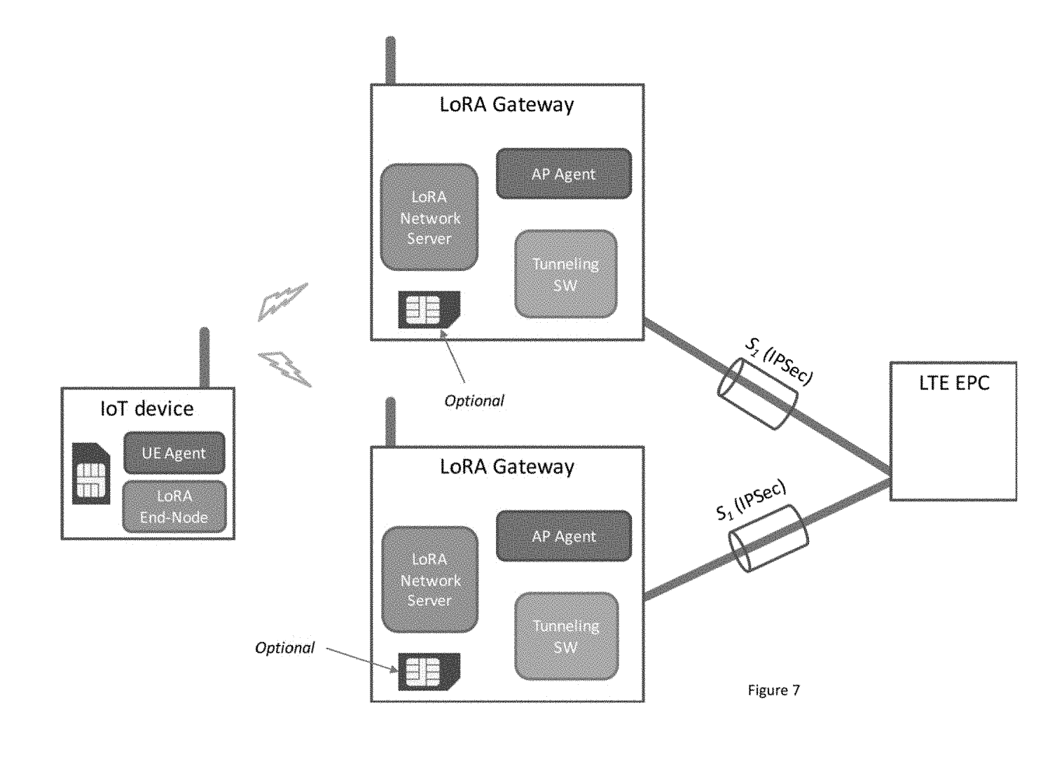

FIG. 7 is a third exemplary implementation of a LoRaWAN network server optimized for a single unified core network, in accordance with the principles described herein. As shown in FIG. 7, various software and/or hardware components required for the integration and operation of LoRaWAN with LTE EPC, are located within an omnibus LoRa gateway. Due to the higher performance requirements, the LoRa gateway must have sufficient memory and processing power for such integration; consequently, the system of FIG. 7 is designed for low volume deployments of a LoRaWAN network.

In the example shown in FIG. 7, the LoRa gateway decides to forward the uplink received packets based on the initial LTE association and authentication of the end-device, otherwise when the end-device is not associated/authenticated then the LoRa gateway ignores the received packets. Mobility may not be supported in the LoRa part of the network for such implementations.

As shown in FIG. 7, the LoRa network server, AP agent, and tunneling software are integrated within the LoRa gateway. In one such exemplary embodiment, the LoRaWAN end-device and/or gateway has been modified to support a USIM card (Universal Subscriber Identity Module) or a SW implementation of the USIM (SW-USIM). As previously noted, the SW-USIM is the SW implementation of the USIM algorithms, with the USIM information kept within a device's secure memory (or encrypted on the device's unsecure memory) and the USIM algorithms executed on a device processor.

Similarly, the processor supports a “UE Agent”; the UE agent can authenticate and attach to an LTE core network. In some variants, the USIM functionality should not be performed within the device; instead, the device USIM functionality is managed in other network nodes such as the LoRa gateway. For example, the LoRa gateway can use the USIM functionality (by proxy) to attach one or more devices to the LTE core network.

In one such variant, the LoRa network server and LoRa end-device replace the LoRa “network session key” (NwkSKey) (defined by the “LoRaWAN Specification”, version 1.0, published January 2015, incorporated herein by reference in its entirety) with an LTE security key. The LoRa network session key and the LTE keys may be characterized by different lengths; consequently, the LTE key can be modified to have the same length as the LoRa network session key. In one such case, the LTE key can be truncated if the LTE key is longer than LoRa NwkSKey (until the LTE key is the same length as the LoRa NwkSKey). Alternatively, the LTE key can be extended by repeating and appending a known part of the LTE key onto itself (until the LTE key is the same length as LoRa NwkSKey). In some implementations, the LoRa Application Session Key (AppSKey) is optional and can be eliminated; conversely, the LoRa AppSkey may be maintained and operated as specified in the aforementioned LoRaWAN Specification, with appropriate modifications.

In another such variant, the LoRa gateway associates and maps the LoRa network server end-device identifiers and the LTE-over-WiFi/LTE UE identifiers. Common examples of LoRaWAN end-device identifiers include e.g., “Device Address” (DevAddr), “End-device Identifier” (DevEUI). Common examples of LTE UE (device) identifiers include without limitation e.g., IP address, IMSI (International Mobile Subscriber Identity), IMEI (International Mobile Equipment Identity), GUTI (Globally Unique Temporary Identifier), TEID (Tunnel endpoint identifier), and any SW identifiers for internal operation of UE and AP Agents. During operation, the end-to-end connection is setup and maintained according to the shared mapping of the LoRa network server end-device identifiers and the LTE-over-WiFi/LTE UE identifiers.

Similarly, other network identifiers may be mapped to one another in order to support cross-network operation. Common examples of other such identifiers include, without limitation, the LoRa “Application identifier” (AppEUI) association. In one exemplary variant, the AppEUI is mapped to a EPC bearer identifier such as the IMSI, TEID and/or LTE APN (Access Point Name). Exemplary mappings are provided and discussed in greater detail hereinafter (see e.g., FIG. 8 and the associated description, infra “Exemplary Glue Software”). In one such implementation, the Glue SW is further appropriately modified for operation within the integrated LoRa gateway.

As previously noted, the LoRa end-device may be required to authenticate with the LTE core network (EPC) and generate a number of security keys before initiating communication. To these ends, the UE agent and AP agent facilitate the authentication and generation of security keys. After the generation of LTE security keys in the end-device and the aggregation gateway, the aggregation gateway passes the generated key to the LoRa network server. Thereafter, the LoRa network server uses the key in place of the LoRa “network session key” (NwkSKey) (as defined by the “LoRaWAN Specification”, version 1.0, published January 2015, incorporated previously), in the same manner as the original LoRa network session key (NwkSKey), as appropriately modified. The end-device will also use the LTE generated security key (which corresponds to the security key used by the LoRa network server) for encryption and decryption of the outgoing and incoming packets respectively. After the generation of the security keys, the resulting security key is used in the LoRa end-point to encrypt uplink packets and decrypt downlink packets, while the corresponding security key in the LoRa network server (logically residing in the LoRa gateway) is used to decrypt uplink packets and encrypt the downlink packets.

After authentication and initial attachment to the LTE network, the UE and AP agents in FIG. 7 communicate through the LoRaWAN network. In some cases, the UE and AP agents use a dedicated local IP address (if necessary) to exchange configuration information. During the initial configuration exchanges, the UE agent will inform the AP agent of the end-device target IoT/IIoT server. In some variants, the UE agent will also inform the AP agent of the target IoT/IIoT server IP Address. Using this information, the AP agent can setup a dedicated LTE bearer (EPS) or use the existing default bearer to support packet transfer to and from the target IoT/IIoT server and the AP agent. During subsequent transfers, the data packets are exchanged between the AP agent and the LoRa network server.

In some implementations, the AP agent and the LoRa network server may additionally use one or more intermediate software abstraction layers. In one variant, the intermediate software abstraction layer is a Glue SW that facilitates data packet exchanges by associating and mapping the end-device LoRaWAN identity to LTE UE identity. One exemplary implementation of Glue SW is discussed in greater detail infra (see e.g., FIG. 8 and the associated description, infra “Exemplary Glue Software”). In one such implementation, the Glue SW is further appropriately modified for operation within the integrated LoRa gateway.

Artisans of ordinary skill in the related arts will readily appreciate that the data packet exchanges between the end-device and the LoRa gateway shown in FIG. 7, are substantially the same as the LoRaWAN operation (as defined by the “LoRaWAN Specification”, version 1.0, published January 2015, incorporated previously). Furthermore, those of ordinary skill will readily appreciate, given the foregoing discussion, that one benefit of the various aforementioned embodiment is that the LoRa end-devices can determine the identity of the LoRa gateway they communicate with. Additionally, since the encryption and decryption occurs at the LoRa gateway, an IPSec tunnel must be present between the LoRa gateway and the LTE EPC so that security can be maintained end-to-end.

### Exemplary Glue Software

Referring now to FIG. 8, one exemplary association and mapping of LoRaWAN and LTE network identities is shown. Artisans of ordinary skill in the related arts will readily appreciate that the following discussion is purely illustrative of methods for providing an identity mapping between two networks. Still other network identities for either LoRaWAN or LTE nodes could be used with equivalent success, and/or the various network identities described herein may not be used within every implementation.

The data packets in a LoRaWAN network are exchanged (as defined by the “LoRaWAN Specification”, version 1.0, published January 2015, incorporated previously). Similarly, the packets in an LTE network part are exchanged according to LTE standards, defined by 3GPP. However, in order to bridge communication from LoRaWAN to LTE and vice versa, the packets from one network must be associated and mapped to the other network entities. In one exemplary embodiment, the “Glue Software (SW)” block provides a two-way mapping of data packets between a LoRa Network Server and an AP Agent. The Glue SW can select the correct identities of the two networks that are associated with a given end-device and network connections, since the Glue SW has access to both network identities. The association mapping can be continually maintained by constructing and updating a table of all the attached LoRa end-devices, and associating their LoRa identities with respective LTE ones. Table 1, shown below, provides one exemplary implementation.

TABLE 1
LoRaWAN-LTE identity association and
mapping table for End-device 1

| | | |
|---|---|---|
| End-Device | | |
| (UE) | LoRaWAN | LTE |

| | | | | |
|---|---|---|---|---|
| 1 | DevAddr | TEID | IP Addr | UDP |
| | DevEUI | IMEI | IP Addr-M | IMSI |
| | AppEUI | IMSI | | |

For example, consider incoming packets from the LoRa network server that have a DevAddr, which is then mapped to the corresponding LTE identifiers, TEID, and IP Addr of the SGW and UDP port. Thereafter, the re-mapped packet is provided to the AP agent for transmission to the LTE EPC. In the reverse direction, incoming packets from the EPC side have the TEID, IP Addr of the SGW and UDP port. The packet is re-mapped to DevAddr, and provided to the LoRa network server for transmission to LoRaWAN.

While the foregoing embodiment is presented in the context of the user datagram protocol (UDP), any other generic data channel may be substituted with equivalent success by artisans of ordinary skill in the related arts given the contents of the present disclosure. As used herein, the term “generic data channel” means any communication protocol that is not specific to an underlying user application. Common examples of such protocols include without limitation: TCP/IP (Transmission Control Protocol/Internet Protocol), HTML (Hypertext Markup Language), RTP (Real Time Transport Protocol), and any number of other widely used protocols within the communication arts.

Myriad other schemes for aggregating network access for a myriad of devices will be recognized by those of ordinary skill given the present disclosure.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. An aggregation gateway configured to aggregate data traffic from different base stations, comprising:
a first interface coupled to a first data channel from a first base station characterized by a first Internet of Things (IoT) radio access technology (RAT);
a second interface coupled to a second data channel from a second base station characterized by a second IoT RAT;
a third interface coupled to a third data channel of a unified core server;
a processor; and
a non-transitory computer readable medium comprising one or more instructions, which when executed by the processor, is configured to cause the aggregation gateway to:
responsive to receiving one or more data packets from either the first data channel or the second data channel;
map the received one or more data packets to corresponding unified packets of a generic data channel; and
transmit the corresponding unified packets to the unified core server.

2. The aggregation gateway of claim 1, wherein the one or more instructions configured to cause the aggregation gateway to map the received one or more data packets to corresponding unified packets, further map a first identity associated with a first device of the first IoT RAT or a second identity associated with a second device of the second IoT RAT to a unique unified network identity of the unified core server.

3. The aggregation gateway of claim 2, wherein the unique unified network identity is associated with a single device when roaming between the first and second IoT RAT.

4. The aggregation gateway of claim 2, wherein the unique unified network identity is associated with a Machine to Machine (M2M) device.

5. The aggregation gateway of claim 4, further comprising one or more instructions, which when executed by the processor, is configured to cause the aggregation gateway to:
initialize and configure the M2M device for direct communication with other M2M devices.

6. The aggregation gateway of claim 2, wherein the third interface coupled to the third data channel of the unified core server comprises an S1 interface to a Long Term Evolution (LTE) Evolved Packet Core (EPC).

7. The aggregation gateway of claim 6, wherein the unique unified network identity is selected from the group consisting of: a unique number, a unique name, an International Mobile Subscriber Identity (IMSI), DevAddr, DevEUI, and APEUI.

8. The aggregation gateway of claim 2, further comprising one or more instructions, which when executed by the processor, is configured to cause the aggregation gateway to:
initialize and configure a first device for direct communication with other devices; and
generate a cryptographic key to enable the direct communication with the other devices.

9. The aggregation gateway of claim 8, wherein the generated cryptographic key comprises a key generated from a Universal Subscriber Identity Module (USIM).

10. The aggregation gateway of claim 8, further comprising one or more instructions, which when executed by the processor, is configured to cause the aggregation gateway to:
issue a fresh key to the first device at a subsequent time to ensure security.

11. A method for connecting a client device of a first radio access technology (RAT) to a unified core server, comprising:
establishing a communication between the client device of the first RAT and a network entity of the first RAT;
providing a first software agent to the client device of the first RAT;
causing execution of the first software agent at the client device;
executing a second software agent at the network entity of the first RAT;
wherein the joint execution of the first software agent and second software agent generate one or more transactions for the unified core server; and
tunneling the one or more transactions to the unified core server.

12. The method of claim 11, wherein the establishing the communication between the client device and the network entity comprises establishing a Wi-Fi connection.

13. The method of claim 11, wherein the joint execution of the first and second software agent to generate one or more transactions comprises generating non-access stratum (NAS) transactions for a Long Term Evolution (LTE) Evolved Packet Core (EPC).

14. The method of claim 13, wherein the tunneling the one or more transactions to the unified core server comprises establishing a S1 interface link to the LTE EPC.

15. A long range wide area network (LoRaWAN) gateway configured to couple to a Long Term Evolution (LTE) Evolved Packet Core (EPC), comprising:
a LoRaWAN radio interface configured to communicate with one or more LoRaWAN clients;
a network interface configured to couple to a LTE EPC;
a processor;
a non-transitory computer readable medium comprising one or more instructions, which when executed by the processor, is configured to cause the LoRaWAN gateway to:
cause execution of a first software agent at a first end device;
execute a second software agent, wherein the joint execution of the first software agent and second software agent generate one or more transactions to authenticate the first end device; and
responsive to successful authentication, attach the first end device to the LTE EPC.

16. The LoRaWAN gateway of claim 15, wherein the authentication of the first end device comprises authentication of a subscriber identity module (SIM) associated with the first end device.

17. The LoRaWAN gateway of claim 16, wherein successful SIM authentication generates a LTE session key; and
wherein the LTE session key replaces one or more Long Range (LoRa) network session key.

18. The LoRaWAN gateway of claim 16, wherein successful SIM authentication verifies a LTE subscriber identifier, and
wherein the LTE subscriber identifier replaces one or more Long Range (LoRa) application identifiers.

19. A method for aggregating Internet of Things (IoT) networks, comprising:
assigning a set of device identifiers of an IoT network to a set of unified identifiers;
storing a mapping of the set of device identifiers to the assigned set of unified identifiers;
receiving one or more packets from the IoT network comprising a first device identifier of the IoT network;
remapping the one or more packets to a corresponding assigned unified identifier; and
transmitting the remapped one or more packets to a unified core server.

20. The method of claim 19, wherein the unified core server comprises a Long Term Evolution (LTE) Evolved Packet Core (EPC) and the set of unified identifiers comprise an International Mobile Equipment Identity (IMEI) or International Mobile Subscriber Identifier (IMSI).

21. An aggregation gateway configured to aggregate data traffic from different communication systems, the aggregation gateway comprising:
a first interface coupled to a first data channel from a first communication system characterized by a first Internet of Things (IoT) radio access technology (RAT);
a second interface coupled to a second data channel associated with a second communication system;
a processor; and
a non-transitory computer readable medium comprising one or more instructions, which when executed by the processor, is configured to cause the aggregation gateway to:
associate at least one first identity of the first communication system with at least one corresponding second identity of the second communication system;
enable connection of the first data channel to the second data channel; and
wherein the enabled connection uses either the at least one first identity or the at least one corresponding second identity to transact data between the first communication system and the second communication system.

22. The aggregation gateway of claim 21, wherein either the at least one first identity or the at least one corresponding second identity comprises an IoT device identifier.
